(19) United States
(12) Patent Application Publication
(10) Pub. No.: US 2025/0224227 A1
(43) Pub. Date: Jul. 10, 2025

(54) MEASUREMENT METHOD AND MEASUREMENT SYSTEM

(71) Applicant: KABUSHIKI KAISHA TOSHIBA, Tokyo (JP)

(72) Inventors: Daisuke HIRATSUKA, Yokohama (JP); Tomoka YOSHINO, Yokohama (JP)

(73) Assignee: KABUSHIKI KAISHA TOSHIBA, Tokyo (JP)

(21) Appl. No.: 18/955,964

(22) Filed: Nov. 21, 2024

(30) Foreign Application Priority Data
Jan. 4, 2024 (JP) 2024-000325

(51) Int. Cl. G01B 11/06

(52) U.S. Cl. CPC G01B 11/0616

(57) ABSTRACT

According to an embodiment, a measurement method includes generating a formula of a relationship between a film thickness of copper oxide and color information of the copper oxide. The film thickness is not more than 15 nm. The measurement method further includes colorimetrically measuring a surface of copper to be measured and calculating a film thickness of copper oxide formed at the surface by applying a colorimetric measurement result in the formula.

### CROSS-REFERENCE TO RELATED APPLICATIONS

This application is based upon and claims the benefit of priority from Japanese Patent Application No. 2024-000325, filed on Jan. 4, 2024; the entire contents of which are incorporated herein by reference.

### FIELD

Embodiments of the invention generally relate to a measurement method and a measurement system.

### BACKGROUND

Copper oxide is formed when copper reacts with oxygen. There is a need for technology that can more simply measure the film thickness of copper oxide formed at a surface of a copper member.

### BRIEF DESCRIPTION OF THE DRAWINGS

FIG. 1 is a flowchart showing a measurement method according to an embodiment;

FIG. 2 is a schematic view showing thin film interference;

FIG. 3 is experiment results illustrating relationships between a copper oxide film thickness and color information;

FIG. 4 is a flowchart showing a measurement method according to a modification of the embodiment;

FIG. 5 is experiment results illustrating the relationship between the color information and the film thickness of CuO;

FIG. 6 is experiment results illustrating the relationship between the color information and the film thickness of Cu₂O;

FIG. 7 is a schematic view showing a measurement system according to an embodiment; and

FIG. 8 is a schematic view illustrating a hardware configuration.

### DETAILED DESCRIPTION

According to an embodiment, a measurement method includes generating a formula of a relationship between a film thickness of copper oxide and color information of the copper oxide, the film thickness being not more than 15 nm. The measurement method includes colorimetrically measuring a surface of copper to be measured and calculating a film thickness of copper oxide formed at the surface by applying a colorimetric measurement result in the formula.

According to another embodiment, a measurement method includes colorimetrically measuring copper oxide by using a method conforming to one of DIN 5033 Teil 7, JIS Z 8722 condition c, ISO 7724/1, CIE No. 15 (2004), or ASTME 1164 (SCI). The measurement method includes generating a formula of a relationship between color information of copper oxide and a film thickness of the copper oxide, the color information having an L-value greater than 53 and less than 82, an a-value greater than 17 and less than 45, and a b-value greater than 24 and less than 43. The measurement method includes colorimetrically measuring a surface of copper to be measured and calculating a film thickness of copper oxide formed at the surface by applying a colorimetric measurement result in the formula.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

Copper oxide is formed at a surface of a copper member by a reaction of copper and oxygen. Embodiments of the invention are used to more simply determine the copper oxide film thickness.

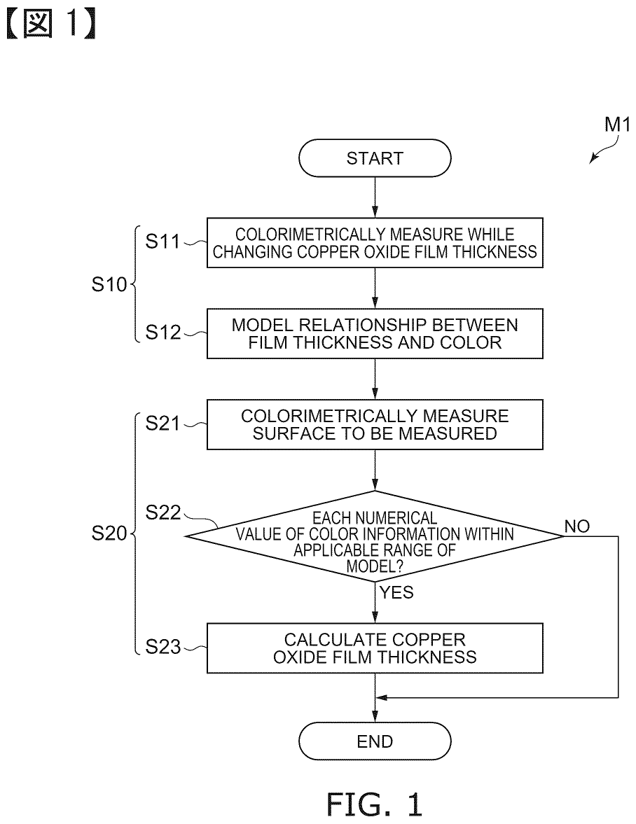

FIG. 1 is a flowchart showing a measurement method according to an embodiment.

As shown in FIG. 1, the measurement method M1 according to the embodiment includes model generation (step S10) and a film thickness measurement (step S20). The model generation includes generating a formula (a model) of a relationship between a film thickness of copper oxide and color information of the copper oxide. The film thickness measurement includes colorimetrically measuring a surface of copper to be measured and calculating a film thickness of copper oxide by using the formula and the colorimetric measurement result. The steps will now be described in detail.

In the model generation, first, copper oxide is colorimetrically measured while changing the copper oxide film thickness (step S11). Multiple sets of measurement data are obtained thereby. Each set of measurement data includes the copper oxide film thickness and color information corresponding to the film thickness. The color information includes numerical values (color values) representing the color. The color is quantified using an XYZ colorimetric system or a Lab colorimetric system. Herein, an example is described in which the color is quantified using a Lab colorimetric system.

A colorimeter is used for the colorimetric measurement. A spectrocolorimeter, a color-difference meter, or the like is used as the colorimeter. Or, a general-purpose camera that includes a CCD image sensor or a CMOS image sensor may be used as the colorimeter. For example, a color image is imaged by an image sensor; and the RGB pixel values at each pixel are converted into the XYZ colorimetric system or the Lab colorimetric system.

The surface of copper is illuminated with light so that the surface can be colorimetrically measured. The surface may be illuminated by using a light source, or may be illuminated with natural light. For example, to suppress the change of the color of the reflected light caused by the light source, it is favorable to perform the colorimetric measurement by using a method conforming to one of DIN 5033 Teil 7, JIS Z 8722 condition c, ISO 7724/1, CIE No. 15 (2004), or ASTME 1164 (SCI).

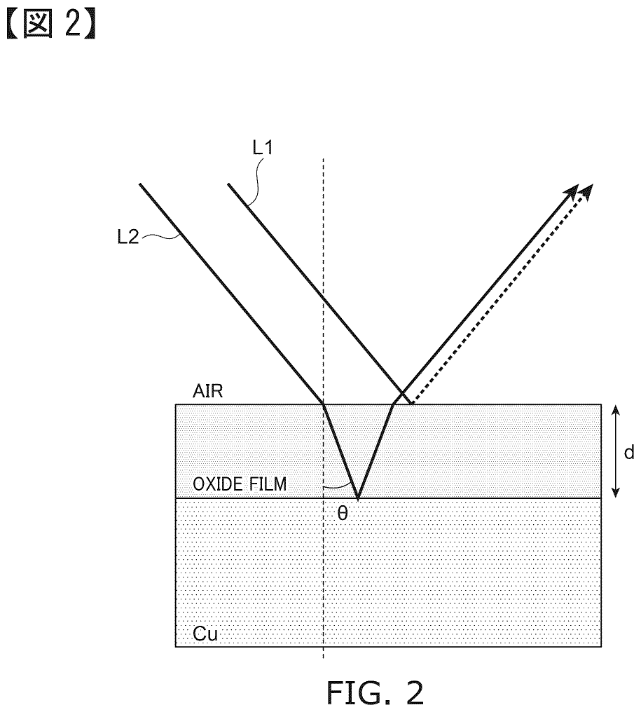

FIG. 2 is a schematic view showing thin film interference.

When thin copper oxide is formed at the surface of copper, thin film interference occurs between a light L1 reflected by the surface of the oxide film and a light L2 reflected by the interface between the Cu and the oxide film as shown in FIG. 2. The copper oxide color changes according to the copper oxide film thickness due to the thin film interference. The thin film interference is represented by the following formula. In the formula, n is the refractive index of the oxide film. d is the copper oxide film thickness. 0 is the refraction angle. A is the wavelength of the incident light.

$$2 nd ( cos θ ) = ( m + 1 / 2 ) λ$$

The measurement method of the embodiment utilizes the thin film interference of the copper oxide to measure the copper oxide film thickness. The thin film interference occurs when the copper oxide film thickness is not more than 15 nm. Accordingly, the measurement method of the embodiment is favorable for measuring film thicknesses of not more than 15 nm.

The composition of copper oxide is mainly CuO and Cu₂O. The refractive index of Cu is 1.2. The refractive index of CuO is 2.6. The refractive index of Cu₂O is 2.7. The refractive index of CuO and the refractive index of Cu₂O are substantially the same, and so the sum of the film thickness of CuO and the film thickness of Cu₂O can be used as one parameter.

The color of copper oxide changes according to the copper oxide film thickness, and so it is also possible to determine the object of the measurement method of the embodiment by the ranges of the color values. For example, copper oxide may be the object of the measurement method of the embodiment when the L-value is greater than 53 and less than 82, the a-value is greater than 17 and less than 45, and the b-value is greater than 24 and less than 43 in a colorimetric measurement result conforming to one of DIN 5033 Teil 7, JIS Z 8722 condition c, ISO 7724/1, CIE No. 15 (2004), or ASTME 1164 (SCI).

After step S11, the multiple sets of measurement data are used to model the relationship between the copper oxide film thickness and the numerical values of the color (step S12). The model is represented by a formula. More specifically, at least one selected from a first formula of the relationship between the copper oxide film thickness and the L-value, a second formula of the relationship between the copper oxide film thickness and the a-value, and a third formula of the relationship between the copper oxide film thickness and the b-value is generated as the formula. For example, the film thickness and the numerical value of the color are represented by a linear relationship in each of the first to third formulas. A response surface methodology can be used for the modeling.

The film thickness is measured after the model generation. First, a colorimeter is used to colorimetrically measure the surface of copper to be measured (step S21). To measure the film thickness with high accuracy, it is favorable to use common conditions for the light source used to collect the measurement data and the light source used to measure the film thickness.

Then, it is determined whether or not the numerical values of the color information obtained by the colorimetric measurement are within the applicable range of the model (step S22). More specifically, it is determined whether or not the L-value of the color information obtained by the colorimetric measurement is within the range from the lower limit to the upper limit of the L-value used to generate the first formula. It is determined whether or not the a-value of the color information is within the range from the lower limit to the upper limit of the a-value used to generate the second formula. It is determined whether or not the b-value of the color information is within the range from the lower limit to the upper limit of the b-value used to generate the third formula. When the L-value, the a-value, and the b-value of the color information each are respectively outside the ranges, there is a possibility that the film thickness calculated using the color information may deviate from the actual film thickness. Accordingly, the color information is not used to calculate the film thickness. For example, when the copper oxide film thickness is greater than 15 nm, the numerical values of the color information may be outside the ranges. When the numerical values of the color information are outside the ranges, the processing ends without calculating the copper oxide film thickness.

When at least one of the numerical values of the color information is within the applicable range of the model, the copper oxide film thickness is calculated using the formula generated in step S12 and the colorimetric measurement result obtained in step S21 (step S23). Specifically, the film thickness is calculated by substituting the measured L-value into the first formula related to the L-value. Or, the film thickness is calculated by substituting the measured a-value into the second formula related to the a-value. Or, the film thickness is calculated by substituting the measured b-value into the third formula related to the b-value.

The film thickness may be calculated using one of the first to third formulas, or may be calculated using two or more of the first to third formulas. For example, when only one of the L-value, the a-value, or the b-value of the color information is within the applicable range of the model in step S22, the film thickness is calculated using only the formula corresponding to the one value. When two or more of the L-value, the a-value, or the b-value of the color information are within the applicable range of the model, the film thickness may be calculated using the formulas corresponding to the two or more values. For example, the final film thickness is calculated by averaging the film thicknesses obtained from the formulas. Or, one model may be selected from two or more models. For example, one model among two or more models having the smallest error for the measurement data utilized to measure the model is selected. In such a case, the film thickness is calculated using the selected model and the color information that is the object of the model. The mean squared error (R²) can be used to compare the errors.

A specific example of the measurement method according to the embodiment will now be described.

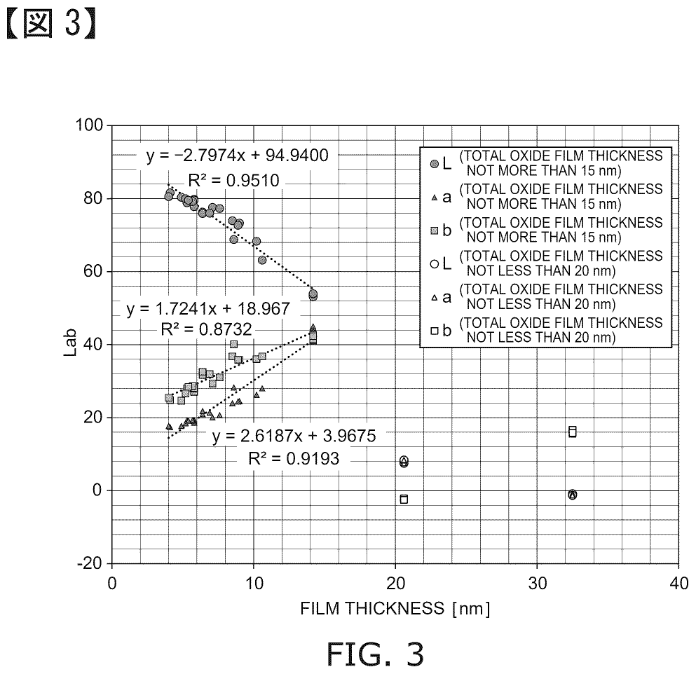

FIG. 3 is experiment results illustrating relationships between the copper oxide film thickness and the color information.

In FIG. 3, the horizontal axis is the copper oxide film thickness. The vertical axis is the L-value, the a-value, or the b-value. The L-value is illustrated by the round plots. The a-value is illustrated by the triangular plots. The b-value is illustrated by the quadrilateral plots. In FIG. 3, the approximation formula of the film thickness and the L-value, the approximation formula of the film thickness and the a-value, and the approximation formula of the film thickness and the b-value are illustrated by broken lines. In the approximation formulas of FIG. 3, the film thickness is represented by “x”; and the L-value, the a-value, or the b-value is represented by “y”.

The graph of FIG. 3 shows the results of colorimetrically measuring copper oxide while changing the copper oxide film thickness from 4 nm to 32.5 nm. The colorimetric measurement was performed using a method conforming to each of DIN 5033 Teil 7, JIS Z 8722 condition c, ISO 7724/1, CIE No. 15 (2004), and ASTME 1164 (SCI). A spectrocolorimeter (CM-25d) made by Konica Minolta, Inc. was used for the colorimetric measurement.

It can be seen from the experiment results shown in FIG. 3 that the film thickness and the color value had a substantially linear relationship when the film thickness was within the range of 4 nm to 14 nm. The relationship between the film thickness and the color value was no longer linear when the film thickness was greater than 20 nm. It is considered that this is because thin film interference due to copper oxide at the copper surface does not easily occur when the film thickness is greater than 15 nm as described above.

The first to third formulas that represent relationships between the film thickness and the color value were generated based on the experiment results shown in FIG. 3. The first formula was expressed by X_{L}=k₁×T+C₁. The second formula was expressed by Xₐ=k₂×T+C₂. The third formula was expressed by X_{b}=k₃×T+C₃. T was the copper oxide film thickness. C₁, C₂, C₃, k₁, k₂, and k₃ were constants. X_{L} was the L-value of the colorimetric measurement result. Xₐ was the a-value of the colorimetric measurement result. X_{b} was the b-value of the colorimetric measurement result.

Specifically, the following first to third formulas were generated based on the experiment results shown in FIG. 3.

$${X}_{L} = - 2.7974 \times T + 94.94 \qquad First formula$$

$${X}_{a} = 2.6187 \times T + 3.9675 \qquad Second formula$$

$${X}_{b} = 1.7241 \times T + 18.967 \qquad Third formula$$

The mean squared error (R²) between the actual measured value of the film thickness and the film thickness calculated based on the measured L-value and the first formula above was 0.951. The mean squared error (R²) between the actual measured value of the film thickness and the film thickness calculated based on the measured a-value and the second formula above was 0.9193. The mean squared error (R²) between the actual measured value of the film thickness and the film thickness calculated based on the measured b-value and the third formula above was 0.8732. It was confirmed that the copper oxide film thickness could be calculated with high accuracy when using each of the formulas.

Advantages of the embodiment will now be described.

Technology that can measure the film thickness of copper oxide more simply is desirable. For example, a power semiconductor chip is bonded with substrate wiring or a leadframe when assembling a power semiconductor device. Solder is mainly used in the bonding. When the bonding surface is oxidized, the wettability of the solder degrades, and the bond becomes difficult to form. Generally, the substrate wiring includes Cu. It is therefore particularly important to measure the copper oxide film thickness.

In recent years, bonding apparatuses for solder bonding that use reductive formic acid gas are increasing. When formic acid gas is used, the likelihood of bonding defects occurring due to the copper oxide film is higher than when bonding with conventional liquid flux. Ag sintered materials also are being used as bonding materials having higher heat dissipation and reliability than solder. When a Ag sintered material is used, the bond is formed by solid-state diffusion of Ag. Ag does not easily form a metallic bond with Cu oxides, and so bonding defects due to copper oxide films occur easily.

Conventionally, the copper oxide film thickness is measured to determine whether or not bonding is possible. Measurement methods of the copper oxide film thickness include a method of combining Ar sputtering and surface analysis (AES or XPS), a method of observing a cross section with an electron microscope (TEM), a method of measuring electrochemically (SERA), and a method of measuring optically (ellipsometry). Non-destructive and simple measurement methods include a measurement method using color tone.

When a copper oxide film thickness measurement is applied to a manufacturing line, it is desirable to be able to measure non-destructively and in a short period of time. All copper members that are manufactured can be the object of the measurement if the film thickness can be measured non-destructively and in a short period of time. Surface analysis, cross-section observation, and electrochemical measurement each require destruction of the object and a long period of time. Methods that use ellipsometry can be performed non-destructively and in a short period of time, but require that the refractive index of the measurement object and other physical characteristics are accurately ascertained. Also, the measurement result easily includes an error if the composition of the measurement object is nonuniform, or if there are micro unevennesses at the surfaces and interfaces. Generally, both CuO and Cu₂O are present in a copper oxide film, and so it is not easy to accurately ascertain the physical characteristics of the measurement object beforehand. Errors of the measurement result may occur according to the interface state of CuO and Cu₂O. Therefore, a simpler measurement method is desirable.

For these problems, according to the embodiment of the invention, the color information of copper oxide is used. Specifically, first, a formula of the relationship between a copper oxide film thickness of not more than 15 nm and color information of the copper oxide is generated. Then, the surface of the copper to be measured is colorimetrically measured. Subsequently, the film thickness of the copper oxide formed at the surface is calculated by applying the colorimetric measurement result in the formula. The colorimetric measurement can be performed non-destructively and in a short period of time. In the measurement method using the colorimetric measurement, it is unnecessary to accurately ascertain the physical characteristics of the measurement object; and the measurement method is simpler than a method that uses ellipsometry. The copper oxide film thickness can be measured with high accuracy even when the copper oxide includes both CuO and Cu₂O. According to the embodiment, the copper oxide film thickness can be measured more simply and in a shorter period of time.

A Lab colorimetric system or an XYZ colorimetric system can be used to quantify the color. The Lab colorimetric system is more favorable than the XYZ colorimetric system. In the Lab colorimetric system, the lightness is represented in the Z-axis; and the chromaticity and the color saturation are represented in the ab-plane. The lightness is independent of the chromaticity and the color saturation, and so the color information can be separated even when an interaction easily occurs between the lightness and the chromaticity or between the lightness and the color saturation.

### Modifications

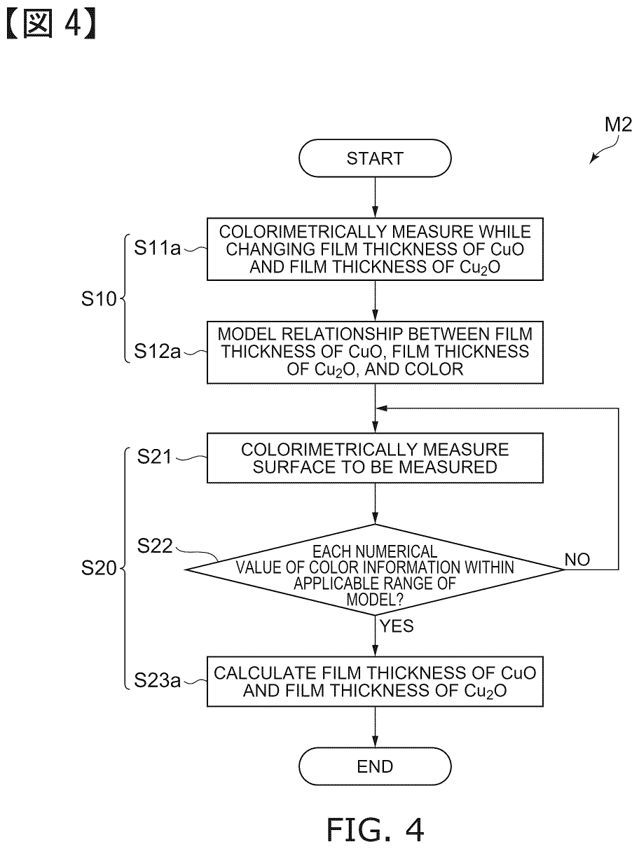

FIG. 4 is a flowchart showing a measurement method according to a modification of the embodiment.

Compared to the measurement method M1 shown in FIG. 1, the measurement method M2 according to the modification shown in FIG. 4 includes step S11a instead of step S11. Also, compared to the measurement method M1, the measurement method M2 includes step S12a instead of step S12, and step S23a instead of step S23.

In the measurement method M1, the sum of the film thickness of CuO and the film thickness of Cu₂O is used as one parameter without discriminating between the film thickness of CuO and the film thickness of Cu₂O. In contrast, in the measurement method M2, the film thickness of CuO and the film thickness of Cu₂O are used as separate parameters. Generally, the oxidization of copper progressively proceeds depthward from the surface. Therefore, Cu₂O forms at the outermost surface of the copper. CuO forms at a position separated from the outermost surface of the copper. In other words, a stacked film of CuO and Cu₂O can be considered to be formed at the copper surface.

In step S11a, multiple sets of measurement data are collected by colorimetrically measuring copper oxide while changing the film thickness of CuO and the film thickness of Cu₂O. The colorimetric measurement result of the stacked film of CuO and Cu₂O is obtained as the color information. The sets of measurement data include the film thickness of CuO, the film thickness of Cu₂O, and the color information corresponding to these film thicknesses.

In step S12a, the multiple sets of measurement data are used to model the relationships between the film thickness of CuO, the film thickness of Cu₂O, and the numerical values of the color. At least one selected from the first formula of the relationship between the film thickness of CuO, the film thickness of Cu₂O, and the L-value, the second formula of the relationship between the film thickness of CuO, the film thickness of Cu₂O, and the a-value, and the third formula of the relationship between the film thickness of CuO, the film thickness of Cu₂O, and the b-value were generated as the formula of the model. Response surface methodology can be used in the modeling.

For example, the first to third formulas are as follows.

$${X}_{L} = {k}_{1} \times {T}_{1} + {k}_{2} \times {T}_{2} + {k}_{3} \times ( {T}_{1} - {C}_{1} ) \times ( {T}_{2} - {C}_{2} ) + {C}_{3} \qquad First formula$$

$${X}_{a} = {k}_{4} \times {T}_{1} + {k}_{5} \times {T}_{2} + {k}_{6} \times ( {T}_{1} - {C}_{4} ) \times ( {T}_{2} - {C}_{5} ) + {C}_{6} \qquad Second formula$$

$${X}_{b} = {k}_{7} \times {T}_{1} + {k}_{8} \times {T}_{2} + {k}_{9} \times ( {T}_{1} - {C}_{7} ) \times ( {T}_{2} - {C}_{8} ) + {C}_{9} \qquad Third formula$$

T₁ is the film thickness of CuO. T₂ is the film thickness of Cu₂O. C₁, C₂, C₃, C₄, C₅, C₆, C₇, C₈, C₉, k₁, k₂, k₃, k₄, k₅, k₆, k₇, k₈, and k₉ are constants. X_{L} is the L-value of the colorimetric measurement result. Xₐ is the a-value of the colorimetric measurement result. X_{b} is the b-value of the colorimetric measurement result.

In step S23a, the film thickness of CuO and the film thickness of Cu₂O are calculated using the color values determined to be within the applicable range of the model in step S22.

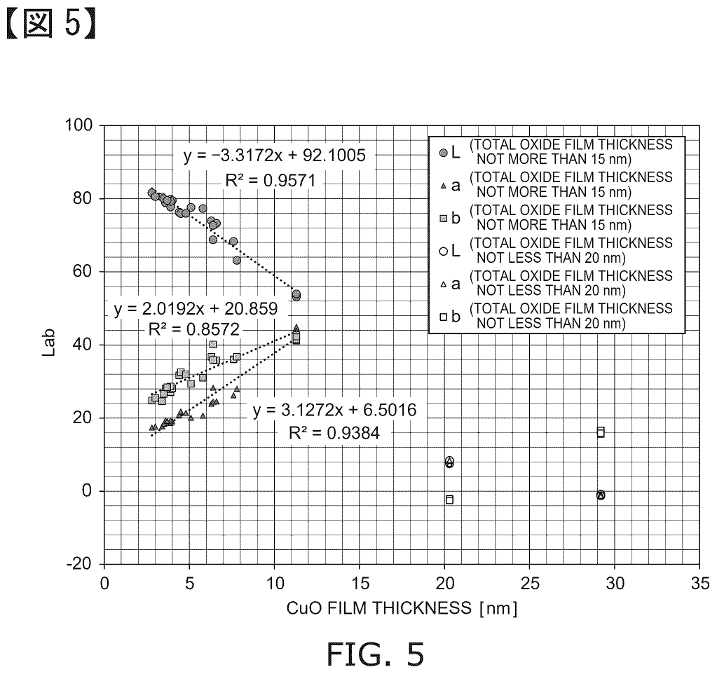

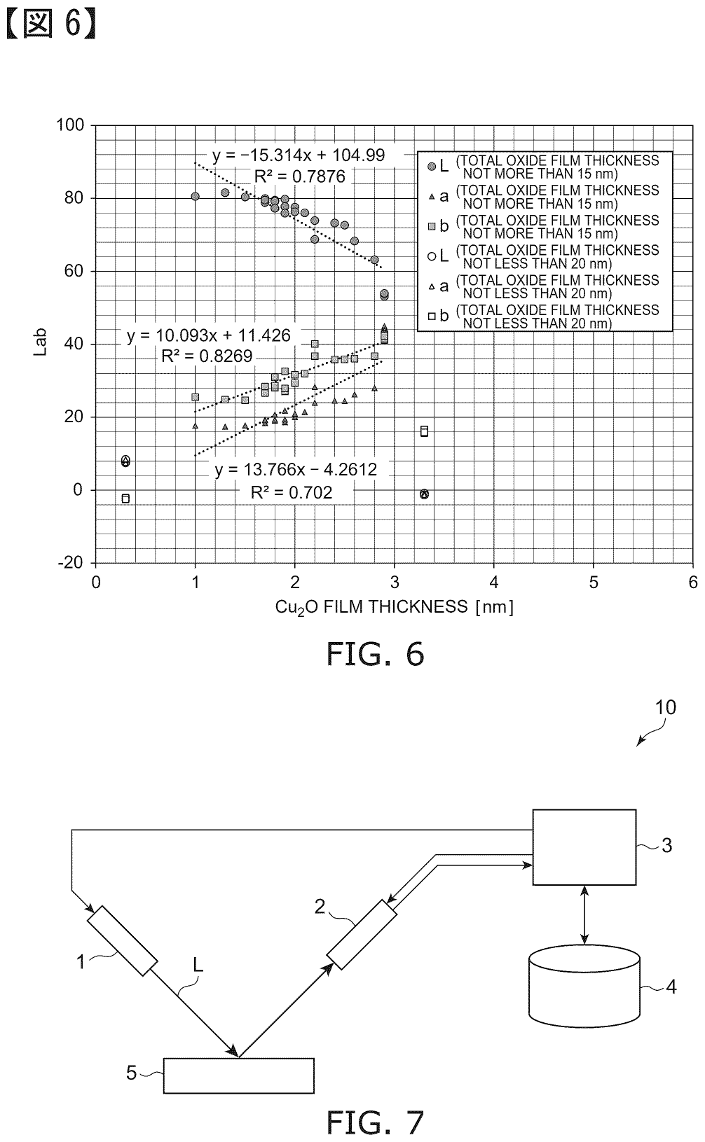

FIG. 5 is experiment results illustrating the relationship between the color information and the film thickness of CuO. FIG. 6 is experiment results illustrating the relationship between the color information and the film thickness of Cu₂O.

The horizontal axis of FIG. 5 is the film thickness of CuO. The horizontal axis of FIG. 6 is the film thickness of Cu₂O. In FIGS. 5 and 6, the vertical axis is the L-value, the a-value, or the b-value. The L-value is illustrated by round plots. The a-value is illustrated by triangular plots. The b-value is illustrated by quadrilateral plots. The graphs of FIGS. 5 and 6 show the colorimetric measurement results when the film thickness of CuO is changed within the range of 2.8 nm to 29.2 nm, and the film thickness of Cu₂O is changed within the range of 0.3 nm to 3.3 nm. The colorimetric measurement was performed using a method conforming to each of DIN 5033 Teil 7, JIS Z 8722 condition c, ISO 7724/1, CIE No. 15 (2004), and ASTME 1164 (SCI). A spectrocolorimeter (CM-25d) made by Konica Minolta, Inc. was used for the colorimetric measurement.

In FIG. 5, the approximation formula of the film thickness of CuO and the L-value, the approximation formula of the film thickness of CuO and the a-value, and the approximation formula of the film thickness of CuO and the b-value are illustrated by broken lines. Similarly, in FIG. 6, the approximation formula of the film thickness of Cu₂O and the L-value, the approximation formula of the film thickness of Cu₂O and the a-value, and the approximation formula of the film thickness of Cu₂O and the b-value are illustrated by broken lines. In the approximation formulas of FIGS. 5 and 6, the film thickness is represented by “x”; and the L-value, the a-value, or the b-value is represented by “y”.

Specifically, the following first to third formulas were generated based on the experiment results shown in FIGS. 5 and 6.

$${X}_{L} = - 1.8127 \times {T}_{1} - 3.6257 \times {T}_{2} + 91.931 \qquad First formula$$

$${X}_{a} = 1.4488 \times {T}_{1} + 1.0634 \times {T}_{2} + 0.0979 \times ( {T}_{1} - 3.3939 ) \times ( {T}_{2} - 3.3939 ) + 11.766 \qquad Second formula$$

$${X}_{b} = 2.6551 \times {T}_{1} + 1.963 \times {T}_{2} - 0.1312 \times ( {T}_{1} - 3.3939 ) \times ( {T}_{2} - 3.3939 ) + 14.785 \qquad Third formula$$

It can be seen from the graph of FIG. 5 that the relationship between the colorimetric measurement result and the color values could be approximated with high accuracy when the film thickness of CuO was within the range of 2.8 nm to 11.3 nm. Also, it can be seen from the graph of FIG. 6 that the relationship between the colorimetric measurement result and the color values could be approximated with high accuracy when the film thickness of Cu₂O was within the range of 1.7 nm to 2.9 nm. When the film thickness of Cu₂O was 0.3 nm, the color values were outside the approximation formulas illustrated by the broken lines. It is considered that this is because when the film thickness of Cu₂O was 0.3 nm, the film thickness of CuO was 20.3 nm, and the sum of these film thicknesses was greater than 15 nm. If the sum of the film thicknesses is not greater than 15 nm, the film thickness of Cu₂O can be measured with high accuracy even when the film thickness of Cu₂O is less than 1.7 nm.

According to the modification, the copper oxide film thickness can be measured by separating into the film thickness of CuO and the film thickness of Cu₂O. For example, reduction treatment of the copper is performed after calculating the copper oxide film thickness. Hydrogen gas, formic acid, etc., are used in the reduction treatment. The copper oxide film thickness is reduced by the reduction treatment. When reduction treatment is to be performed, the equipment used to perform the reduction treatment can be appropriately selected according to the film thickness of CuO and the film thickness of Cu₂O by measuring these film thicknesses separately. Also, the reduction treatment conditions can be adjusted according to the film thickness of CuO and the film thickness of Cu₂O that are measured.

FIG. 7 is a schematic view showing a measurement system according to an embodiment.

The measurement system 10 shown in FIG. 7 includes a light source 1, a colorimeter 2, a measurement device 3, and a storage device 4. The light source 1 illuminates the surface of a copper member 5 to be measured by causing a light L to strike the surface. For example, the light source 1 includes an LED. The colorimeter 2 detects the reflected light from the surface of the copper member 5 and colorimetrically measures the surface of the copper member 5. The measurement device 3 controls the operations of the light source 1 and the colorimeter 2. The measurement device 3 also receives the colorimetric measurement result from the colorimeter 2. The storage device 4 stores a pre-generated model (formula). When receiving the colorimetric measurement result, the measurement device 3 obtains the formula from the storage device 4. The measurement device 3 uses the formula and the colorimetric measurement result to measure the copper oxide film thickness formed at the surface to be measured.

The measurement device 3 also may determine the goodness of the copper member 5 based on the measured film thickness. For example, the measurement device 3 compares the measured film thickness to a preset threshold. When the film thickness is greater than the threshold, the measurement device 3 determines the copper member 5 to be defective.

According to the measurement system 10, the film thickness of copper oxide formed at the surface of the copper member 5 is measured more simply and in a shorter period of time. For example, by using the measurement system 10, all of the copper members 5 that are manufactured can be inspected.

The measurement system 10 also can be used when generating the model. Measurement data can be collected by the light source 1 illuminating a copper surface and by colorimetrically measuring the surface with the colorimeter 2. A model is generated using the collected measurement data. The model may be generated by the measurement device 3, or may be generated by another processing device.

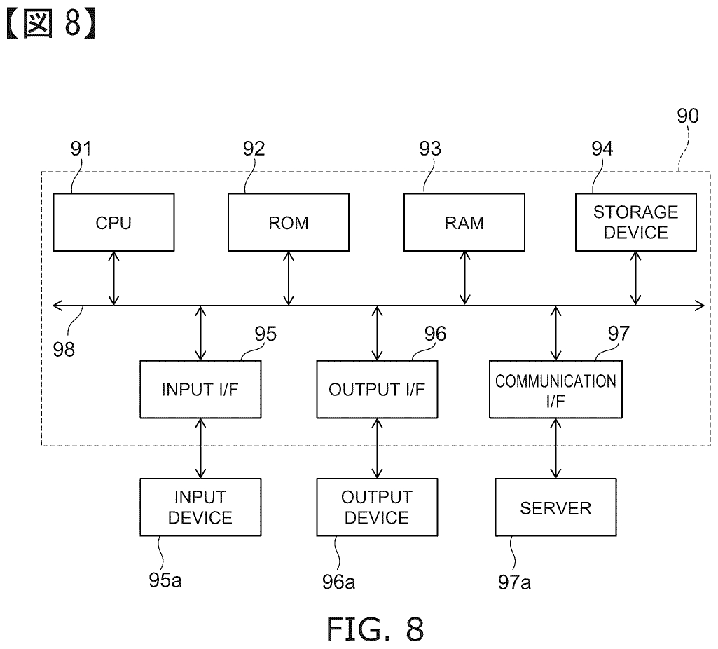

FIG. 8 is a schematic view illustrating a hardware configuration.

For example, a computer 90 shown in FIG. 8 is used as the measurement device 3. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HPMI (registered trademark)), etc. The CPU 91 can transmit data to the output device 96a via the output I/F 96 and can cause the output device 96a to display an image.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing that is performed by the measurement device 3 may be realized by one computer 90 or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

According to the embodiments above, a measurement method and a measurement system are provided in which the film thickness of copper oxide can be measured more simply and in a shorter period of time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A measurement method, comprising:
generating a formula of a relationship between a film thickness of copper oxide and color information of the copper oxide, the film thickness being not more than 15 nm; and
colorimetrically measuring a surface of copper to be measured and calculating a film thickness of copper oxide formed at the surface by applying a colorimetric measurement result in the formula.

2. The measurement method according to claim 1, wherein
the color information is represented using a Lab colorimetric system,
the formula includes at least one selected from:
$$a first formula expressed by {X}_{L} = {k}_{1} \times T + {C}_{1} ;$$
$$a second formula expressed by {X}_{a} = {k}_{2} \times T + {C}_{2} ; and$$
$$a third formula expressed by {X}_{b} = {k}_{3} \times T + {C}_{3} ,$$
T is a film thickness of copper oxide,
C₁, C₂, C₃, k₁, k₂, and k₃ are constants,
X_{L} is an L-value of the colorimetric measurement result,
Xₐ is an a-value of the colorimetric measurement result, and
X_{b} is a b-value of the colorimetric measurement result.

3. The measurement method according to claim 2, wherein
the formula includes the first formula, the second formula, and the third formula.

4. The measurement method according to claim 1, wherein
the formula is of a relationship between the color information and a combination of a film thickness of CuO and a film thickness of Cu₂O, and
a film thickness of CuO and a film thickness of Cu₂O formed at the surface are measured by applying the colorimetric measurement result in the formula.

5. The measurement method according to claim 4, wherein
the color information is represented using a Lab colorimetric system,
the formula includes at least one selected from:
$$a first formula expressed by {X}_{L} = {k}_{1} \times {T}_{1} + {k}_{2} \times {T}_{2} + {k}_{3} \times ( {T}_{1} - {C}_{1} ) \times ( {T}_{2} - {C}_{2} ) + {C}_{3} ;$$
$$a second formula expressed by {X}_{a} = {k}_{4} \times {T}_{1} + {k}_{5} \times {T}_{2} + {k}_{6} \times ( {T}_{1} - {C}_{4} ) \times ( {T}_{2} - {C}_{5} ) + {C}_{6} ; and$$
$$a third formula expressed by {X}_{b} = {k}_{7} \times {T}_{1} + {k}_{8} \times {T}_{2} + {k}_{9} \times ( {T}_{1} - {C}_{7} ) \times ( {T}_{2} - {C}_{8} ) + {C}_{9} ,$$
T₁ is a film thickness of CuO,
T₂ is a film thickness of Cu₂O,
C₁, C₂, C₃, C₄, C₅, C₆, C₇, C₈, C₉, k₁, k₂, k₃, k₄, k₅, k₆, k₇, k₈, and k₉ are constants,
X_{L} is an L-value of the colorimetric measurement result,
Xₐ is an a-value of the colorimetric measurement result, and
X_{b} is a b-value of the colorimetric measurement result.

6. A measurement method, comprising:
colorimetrically measuring copper oxide by using a method conforming to one of DIN 5033 Teil 7, JIS Z 8722 condition c, ISO 7724/1, CIE No. 15 (2004), or ASTME 1164 (SCI);
generating a formula of a relationship between color information of copper oxide and a film thickness of the copper oxide, the color information having an L-value greater than 53 and less than 82, an a-value greater than 17 and less than 45, and a b-value greater than 24 and less than 43; and
colorimetrically measuring a surface of copper to be measured and calculating a film thickness of copper oxide formed at the surface by applying a colorimetric measurement result in the formula.

7. The measurement method according to claim 6, wherein
the color information is represented using a Lab colorimetric system,
the formula includes at least one selected from:
$$a first formula expressed by {X}_{L} = {k}_{1} \times T + {C}_{1} ;$$
$$a second formula expressed by {X}_{a} = {k}_{2} \times T + {C}_{2} ; and$$
$$a third formula expressed by {X}_{b} = {k}_{3} \times T + {C}_{3} ,$$
T is a film thickness of copper oxide,
C₁, C₂, C₃, k₁, k₂, and k₃ are constants,
X_{L} is an L-value of the colorimetric measurement result,
Xₐ is an a-value of the colorimetric measurement result, and
X_{b} is a b-value of the colorimetric measurement result.

8. The measurement method according to claim 7, wherein
the formula includes the first formula, the second formula, and the third formula.

9. The measurement method according to claim 6, wherein
the formula is of a relationship between the color information and a combination of a film thickness of CuO and a film thickness of Cu₂O, and
a film thickness of CuO and a film thickness of Cu₂O formed at the surface are measured by applying the colorimetric measurement result in the formula.

10. The measurement method according to claim 9, wherein
the color information is represented using a Lab colorimetric system,
the formula includes at least one selected from:
$$a first formula expressed by {X}_{L} = {k}_{1} \times {T}_{1} + {k}_{2} \times {T}_{2} + {k}_{3} \times ( {T}_{1} - {C}_{1} ) \times ( {T}_{2} - {C}_{2} ) + {C}_{3} ;$$
$$a second formula expressed by {X}_{a} = {k}_{4} \times {T}_{1} + {k}_{5} \times {T}_{2} + {k}_{6} \times ( {T}_{1} - {C}_{4} ) \times ( {T}_{2} - {C}_{5} ) + {C}_{6} ; and$$
$$a third formula expressed by {X}_{b} = {k}_{7} \times {T}_{1} + {k}_{8} \times {T}_{2} + {k}_{8} \times ( {T}_{1} - {C}_{7} ) \times ( {T}_{2} - {C}_{8} ) + {C}_{9} ,$$
T₁ is a film thickness of CuO,
T₂ is a film thickness of Cu₂O,
C₁, C₂, C₃, C₄, C₅, C₆, C₇, C₈, C₉, k₁, k₂, k₃, k₄, k₅, k₆, k₇, k₈, and k₉ are constants,
X_{L} is an L-value of the colorimetric measurement result,
Xₐ is an a-value of the colorimetric measurement result, and
X_{b} is a b-value of the colorimetric measurement result.

11. A measurement system, comprising:
a light source configured to illuminate a surface of copper to be measured;
a colorimeter configured to colorimetrically measure the illuminated surface; and
a measurement device configured to measure a film thickness of copper oxide formed at the surface by applying a colorimetric measurement result of the colorimeter in a formula of a relationship between a film thickness and color information of copper oxide, the film thickness being not more than 15 nm.
